(19) United States
(12) Patent Application Publication
(10) Pub. No.: US 2008/0311328 A1
(43) Pub. Date: Dec. 18, 2008

(54) NON-HALOGEN FLAME RETARDANT RESIN COMPOSITION AND NON-HALOGEN FLAME RETARDANT ELECTRIC WIRE AND CABLE

(76) Inventor: Hitoshi KIMURA, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/136,856

(22) Filed: Jun. 11, 2008

(30) Foreign Application Priority Data
Jun. 13, 2007 (JP) 2007-156228
Apr. 24, 2008 (JP) 2008-114157

(51) Int. Cl. C08K 3/34; B32B 1/08

(52) U.S. Cl. 428/36.91; 524/456

(57) ABSTRACT

An insulator 2 cladding the conductor 1 and/or a cable sheath 4 cladding the insulated electric wire 11 are formed by using a resin composition formed by mixing 100 to 250 parts by weight of silanized magnesium hydroxide together with 100 parts by weight of polymer composed of 50 to 80 parts by weight of ethylene-vinyl acetate copolymer, 10 to 30 parts by weight of polypropylene, and 10 to 20 parts by weight of magnesium hydroxide denatured with maleic acid obtained by denaturing copolymerized polymer with maleic anhydride, the copolymerized polymer being formed by copolymerizing ethylene and the co-monomer of alpha-olefin of carbon numbers 3 to 8.

### BACKGROUND OF THE INVENTION

The present invention relates to non-halogen flame retardant resin composition and non-halogen flame retardant electric wires and cables, specifically to non-halogen flame retardant electric wires and cables which provide excellent flame retardant property and environmental compatibility.

In recent years, non-halogen flame retardant electric wires and cables which are not composed of polyvinyl chloride or halogen flame retardant have become rapidly used widely as eco-friendly electric wires and cables. In the conventional non-halogen flame retardant electric wires and cables, it is general that the insulator for electric wires and the sheath for cables use resin compositions formed by mixing polyolefin together with non-halogen flame retardant such as magnesium hydroxide.

These prior arts are disclosed, for example, in Japanese Publication Numbers P2003-160704A (2003) to K. KOBAYASHI et al of Riken Technos Corporation or P10-287777A (1998) to A. NAKAYAMA of Hitachi Cable LTD.

### BRIEF SUMMARY OF THE INVENTION

In making flame retardant electric wires and cables by using non-halogen flame retardant such as magnesium hydroxide, it is required to mix large quantity of non-halogen flame retardant. This may cause such a problem that the mechanical characteristics and extension property of the insulator of electric wires and the cable sheath may be seriously reduced.

Alternately, there is such a method that the volume of non-halogen flame retardant is intentionally reduced by adding flame retardant aids such as red phosphorus. As this method is recognized to give such problems that red phosphorus generates phosphine harmful to human body when burning, and that phosphoric acid generated when disposing may contaminate the water flowing beneath the surface of the earth, there is recently a trend toward disuse of red phosphorus.

An object of the present invention is to solve the above problem and to provide non-halogen flame retardant electric wires and cables which have excellent features in flame retardant property, mechanical strength and extension property without using red phosphorus and halogen flame retardant.

In one aspect, the present invention is a non-halogen flame retardant resin composition formed by mixing 100 to 250 parts by weight of silanized magnesium hydroxide together with 100 parts by weight of polymer composed of 50 to 80 parts by weight of ethylene-vinyl acetate copolymer, 10 to 30 parts by weight of polypropylene, and 10 to 20 parts by weight of magnesium hydroxide denatured with maleic acid obtained by denaturing copolymerized polymer with maleic anhydride, the copolymerized polymer being formed by copolymerizing ethylene and the co-monomer of alpha olefin of carbon numbers 3 to 8.

In another aspect, the present invention is the above described resin composition having a coefficient of extension of 200% or larger when being extended at the velocity between 300 mm/min and 500 mm/min in accordance with UIC (The International Union of Railways) Standard.

In a further aspect, the present invention is a non-halogen flame retardant electric wire characterized by an insulator layer formed by the resin composition described above for cladding the conductor.

In a further aspect, the present invention is a non-halogen flame retardant cable characterized by a cable sheath formed by the resin composition described above for cladding the insulated wire.

According to the present invention, it will be appreciated that non-halogen flame retardant resin composition and non-halogen electric wires and cables can be obtained so as to provide high flame retardant property and excellent mechanical characteristics as well as eco-friendly features without cross-linking treatment.

### BRIEF DESCRIPTION OF THE SEVERAL VIEWS OF THE DRAWING

FIG. 1 is a cross-section view illustrating a flame retardant cable (including a flame retardant electric wire) in a preferred embodiment according to the present invention.

### DETAILED DESCRIPTION OF THE INVENTION

Now, one preferred embodiment of the present invention will be described in detail by referring to an attached figure.

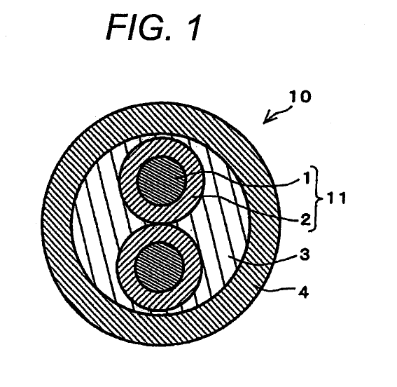

FIG. 1 is a cross-section view illustrating a preferred embodiment of the non-halogen flame retardant electric wire and cable according to the present invention.

As shown in FIG. 1, the non-halogen flame retardant cable (hereinafter referred to as flame retardant cable) 10 of this preferred embodiment comprises the core formed by a twisted pair of two and parallel non-halogen flame retardant electric wires (hereinafter referred to as flame retardant electric wire) 11 with intermediate material 3 and the cable sheath (sheath) 4 composed of non-halogen flame retardant resin composition as a cladding material for the core.

The flame retardant electric wire 11 is formed by cladding the conductor 1 at its outer periphery with the insulator (layer) 2 composed of non-halogen flame retardant resin composition.

The conductor 1 is composed of either Cu alone or Cu alloy, and the intermediate material 3 is composed of polypropylene.

The resin composition used for forming the insulator 2 and the sheath 4 is made by adding magnesium hydroxide denatured with maleic acid (hereinafter referred to as M-PO) to the polymer blends of ethylene-vinyl acetate copolymer (hereinafter referred to as EVA) and polypropylene (hereinafter referred to as PP) and further mixing silanized magnesium hydroxide together as flame retardant agent.

The blending ratios of individual materials are defined as 100 parts by weight of polymer composed of 50 to 80 parts by weight of EVA, 10 to 30 parts by weight of PP and 10 to 20 parts by weight of M-PO, and 100 to 250 parts by weight of silanized magnesium hydroxide.

As for PP, isotactic PP and syndiotactic PP are typical, and either homogenous PP, block PP or random PP including ethylene series copolymer compositions may be selected.

The reason for the blending ratios of 50 to 80 parts by weight of EVA and 10 to 30 parts by weight of PP is that, the flame retardant property is reduced for 50 or less parts by weight of EVA and the mechanical characteristic (especially, heat deformation property) is extremely reduced due to the lower ratio of PP for 80 or more parts by weight of EVA. Preferably, 50 to 60 parts by weight of EVA and 20 to 30 parts by weight of PP are selected.

M-PO has functionality for increasing the mechanical strength by bonding the interface between polymer blends (EVA and PP) and silanized magnesium hydroxide. Preferably, M-PO is formed by the copolymer, such as ethylene propylene copolymer and ethylene butane copolymer, those formed by copolymerizing ethylene and co-monomer of alpha olefin of carbon numbers 3 to 8, and denatured with maleic anhydride. Being compared with the composition denatured with maleic acid such as polyethylene, polypropylene, ethylene ethyl acrylate copolymer, ethylene vinyl acetate copolymer, those used in the conventional flame retardant electric wires and cables, M-PO has excellent functionality as compatibility accelerator for EVA/PP alloys, and the tensile property is less reduced in the highly filled system of flame retardant agent (resin composition mixed with large amount of flame retardant agent) because the amount of crystals in M-PO itself is small. The reason for defining 10 to 20 parts by weight of M-PO is that the bonding between polyolefin and metal hydride becomes weak and enough mechanical strength can not be obtained for 10 or less parts by weight of M-PO, and that the tensile property of the insulator 2 or the sheath 4 is reduced to a large extent for 20 or more parts by weight of M-PO.

As for the silane coupling agent used for surface treatment for silanized magnesium hydroxide, vinyl tri-ethoxy silane, methacrylic silane and amino silane are generally known agents, and are used for surface treatment in the known methods. The reason for defining 100 to 250 parts by weight of silanized magnesium hydroxide to be mixed is that the flame retardant property is reduced for 100 or less parts by weight of silanized magnesium hydroxide and the mechanical characteristic (especially, tensile property) is extremely reduced for 250 or more parts by weight of silanized magnesium hydroxide. It is allowed to add appropriately magnesium hydroxide treated with fatty acid such as stearic acid to silanized magnesium hydroxide.

The insulator 2 or sheath 4 formed by the flame retardant resin composition obtained according to the above blending rations provides a coefficient of extension of 200% or larger when being extended at the velocity between 300 mm/min and 500 mm/min in accordance with UIC (The International Union of Railways) Standard.

The coefficient of extension is obtained by the following way;

At first, a dumbbell shaped specimen may be cut out from the insulator or sheath; next, a gauge mark with a designated length (gauge length=L₀) may be marked at the center part (1 mm wide and 20 mm length, or larger) of the dumbbell shaped specimen; then, this specimen may be pulled by the tensile strength tester, and finally the gauge length L₁ measured when break gives the coefficient of extension E₀ according to the following formula:

E₀={(L₁−L₀)/L₀}×100

The effect of the flame retardant electric wire and cable in this embodiment is described below.

For the flame retardant electric wire 11 in this embodiment, it will be appreciated that the compatibility between EVA and PP can be increased by adding M-PO to the polymer blends of EVA and PP, and that excellent tensile property can be obtained even by mixing large amount of flame retardant agent into the insulator 2 and the sheath 4 in order to increase the flame retardant property. It will be appreciated especially that the flame retardant electric wire 11 in this embodiment provides a good strength property which was proved by the tensile testing at the velocity of 300 mm/min in compliance with UIC (The International Union of Railways) Standard.

It will be also appreciated that the insulator 2 has an excellent heat deformation property without cross-linking treatment, owing to effectively uniform dispersion of PP with high-melting point.

Though the flame retardant electric wire 11 itself can be used (that is, its mechanical strength can be maintained) at the rated temperature of 105° C. without cross-linking treatment, it is allowed to use also the flame retardant electric wire 11 finished by applying cross-linking treatment in the known method such as radiation exposure with electron beam or ultraviolet ray, or organic peroxides.

As the flame retardant cable 10 in this embodiment has the sheath 4 formed with the same resin composition as the insulator 2 of the flame retardant electric wire 11, the flame retardant cable 10 also gives the same effect as the flame retardant electric wire 11 does.

In the present invention, in addition to the above described compositions, other compositions such as cross-linking aids, flame retardant aids, anti-oxidizing agents, lubricants, stabilizing agents, filling materials, coloring agent and silicon may be added.

Though both of the insulator 2 and the sheath 4 in the flame retardant cable 10 shown in FIG. 1 are composed of the above described resin compositions, only the sheath 4 in the flame retardant cable 10 in the present invention may be composed of the above described resin compositions.

The flame retardant compositions forming the insulator 2 and the sheath 4 can be applied to, for example, flat cables, hand-rails for escalators and nonflammable films other than electric wires and cables with circular cross section.

### Embodiment

Now, the preferred embodiments of the present invention will be described based on some practical embodiments. The preferred embodiments of the present invention are not limited to those practical embodiments.

### Electric Wire Embodiments 1 to 3

### 1. Preparation of Specimen

Flame retardant electric wires as Embodiments and Comparative Examples may be fabricated in the following steps; at first, the compositions shown in Table 1 are mixed in a 3 (three) litter kneading machine with its temperature maintained between 180° C. to 200° C., then, the mixed material with its temperature maintained at 180° C. may be extruded by a 40 mm extruding machine (with longitudinal diameter ratio L/D=24) and, finally the cladding with 1 mm thickness may be formed on the twisted-pair 2SQ Cu-made wires.

### Cable Embodiments 1 to 6

Cable shown in FIG. 1 may be fabricated in the following steps; the core may be formed with the twisted-pair of flame retardant electric wires and the intermediate material composed of polypropylene, next, the non-halogen resin compositions shown in Table 1 with its temperature maintained at 180° C. may be extruded on the core as a sheath (with approximately 1 mm thickness) by a 40mm extruding machine (with longitudinal diameter ratio L/D=24).

### COMPARATIVE EXAMPLES (CABLE) 1 TO 6

Cables may be fabricated in the similar manner to Embodiments (Cable) 1 to 6 by using the resin compositions with their blending ratios shown in Table 2.

The fabricated electric wires and cables may be estimated in the following procedures.

### (1) Tensile Property

As for the electric wires, the tube remained after removing the conductor is used for tensile testing in compliance with JIS C3005. As for the cables, the sheath removed from the cable is cut out in dumbbell #3 shape, and then used for tensile testing in compliance with JIS K6251. In both cases for electric wires and cables, the extension velocity may be set to 300 mm/min (refer to UIC Code 897). The criteria for tensile strength and coefficient of extension are defined to be 12 MPa or more (12 MPa≦) and 250% or more (250%≦), respectively.

### (2) Heat Deformation Property

Heat deformation property is estimated in compliance with UIC Code 897. As for the electric wires, the electric wire itself may be used as the specimen without removing the conductor. As for the cables, the dimension of the specimen may be adjusted so that the length may be 40 mm and the width is about ⅓ of the circumferential length of the cable. The prepared specimen may be preheated for 16 hours in the constant temperature reservoir with its inside temperature maintained 100° C., and after that, a designated load may be applied to the specimen for 4 (four) hours at 100° C. The criterion for the deformation is defined to be 50% or less. The applied load is calculated according to the following formula;

F(N)=0.8\sqrt{(2De−e²)}

where e is the thickness of the sheath or the insulator in mm, and D is the average outer diameter of the cable in mm.

### (3) Flame Retardant Property

Flame retardant property of the electric wires and cables are estimated at the vertical disposition (with the inclination angle at 90°) in compliance with UIC Code 897. The criteria are that the specimen is acceptable if the fire is extinguished within 30 seconds after ignited and burned for about 60 seconds, and that the specimen is rejected if the specimen continues to burn for 30 seconds or longer after ignited and burned for about 60 seconds.

TABLE 1

| | | Embodiments | | | | | | | | |
|---|---|---|---|---|---|---|---|---|---|---|
| | | (Electric Wire) | | | Embodiments (Cable) | | | | | |
| Items | | 1 | 2 | 3 | 1 | 2 | 3 | 4 | 5 | 6 |
| Blending | EVA (YX21, product of TOSOH CORPORATION) | 50 | 50 | | 30 | 40 | 50 | 60 | 70 | 80 |
| Ratios | EVA (EV260, product of DU PONT-MITSUI | | | 40 | | | | 10 | | |
| | POLYCHEMICALS CO., LTD.) | | | | | | | | | |
| | EVA (EV170, product of DU PONT-MITSUI | | 20 | 40 | 20 | 20 | 15 | | | |
| | POLYCHEMICALS CO., LTD.) | | | | | | | | | |
| | PP (EC8D, product of Japan Polypropylene | 30 | | | | | | 20 | | 10 |
| | Corporation) | | | | | | | | | |
| | PP (BC6D, product of Japan Polypropylene | | 20 | 10 | 30 | 30 | 25 | | 10 | |
| | Corporation) | | | | | | | | | |
| | Ethylene propylene copolymer denatured with | 20 | | | | 10 | | 10 | | 10 |
| | maleic acid (TAFMER MP0620, product of Mitsui | | | | | | | | | |
| | Chemicals, Inc.) | | | | | | | | | |
| | Ethylene butane copolymer denatured with maleic | | 10 | 10 | 20 | | 10 | | 20 | |
| | acid (TAFMER MH7020, product of Mitsui | | | | | | | | | |
| | Chemicals, Inc.) | | | | | | | | | |
| | Silanized magnesium hydroxide (Magseeds S4, | 150 | | | 150 | | 100 | | 100 | |
| | Konoshima Chemical Co., Ltd.) | | | | | | | | | |
| | Silanized magnesium hydroxide (KX400H, product | | 100 | 120 | | 150 | | 180 | 50 | 100 |
| | of Konoshima Chemical Co., Ltd.) | | | | | | | | | |
| | Magnesium hydroxide treated with stearic acid | | 60 | 80 | | | 60 | 70 | 50 | |
| | (Magseeds N4, product of Konoshima Chemical | | | | | | | | | |
| | Co., Ltd.) | | | | | | | | | |
| | IRGANOX 1010 (product of Chiba-Geigy K.K.) | 1 | 1 | 1 | 1 | 1 | 1 | 1 | 1 | 1 |
| Estimation | Tensile Strength (Mpa) Criterion: 12 Mpa or | 18.6 | 14.6 | 13.5 | 16.4 | 13.9 | 15.1 | 12.5 | 12.4 | 16.8 |
| Results | more (12≦) | | | | | | | | | |
| | Extension (%) Criterion: 250% or more | 360 | 420 | 340 | 400 | 390 | 400 | 300 | 310 | 480 |
| | (250≦) | | | | | | | | | |
| | Heat Deformation (%) Criterion: 50% or less | 5.4 | 10.5 | 12.8 | 11.2 | 13.7 | 8.7 | 5.6 | 25.7 | 38.2 |
| | (50≧) | | | | | | | | | |
| | Flame Retardant (VFT) Criterion: Fire | ◯ | ◯ | ◯ | ◯ | ◯ | ◯ | ◯ | ◯ | ◯ |
| | extinguished within 30 seconds. | | | | | | | | | |

TABLE 2

| | | Embodiments (Cable) | | | | | |
|---|---|---|---|---|---|---|---|
| Items | | 1 | 2 | 3 | 4 | 5 | 6 |
| Blending | EVA (YX21, product of TOSOH CORPORATION) | 20 | 85 | 80 | | 70 | 70 |
| Ratios | EVA (EV260, product of DU PONT-MITSUI POLYCHEMICALS CO., | 15 | | | 50 | | |
| | LTD.) | | | | | | |
| | EVA (EV170, product of DU PONT-MITSUI POLYCHEMICALS CO., | | | | | | |
| | LTD.) | | | | | | |
| | PP (EC8D, product of Japan Polypropylene Corporation) | 50 | | | | | |
| | PP (BC6D, product of Japan Polypropylene Corporation) | | 5 | 15 | 20 | 10 | 10 |
| | Ethylene propylene copolymer denatured with maleic acid (TAFMER | 15 | | | 30 | | |
| | MP0620, product of Mitsui Chemicals, Inc.) | | | | | | |
| | Ethylene butane copolymer denatured with maleic acid (TAFMER | | 10 | 5 | | | 20 |
| | MH7020, product of Mitsui Chemicals, Inc.) | | | | | | |
| | EEA denatured with maleic acid | | | | | 20 | |
| | Silanized magnesium hydroxide (Magseeds S4, Konoshima Chemical | 150 | | 90 | 150 | 100 | 160 |
| | Co., Ltd.) | | | | | | |
| | Silanized magnesium hydroxide (KX400H, product of Konoshima | | 150 | | | 50 | |
| | Chemical Co., Ltd.) | | | | | | |
| | Magnesium hydroxide treated with stearic acid (Magseeds N4, product of | | | | | 50 | |
| | Konoshima Chemical Co., Ltd.) | | | | | | |
| | NOCRAC 224 (product of OUCHISHINKO CHEMICAL INDUSTRIAL | 1 | 1 | 1 | 1 | 1 | 1 |
| | CO., LTD.) | | | | | | |
| Estimation | Tensile Strength (Mpa) Criterion: 12 Mpa or more (12≦) | 21.6 | 10.7 | 11.4 | 16.7 | 12.8 | 10.1 |
| Results | Extension (%) Criterion: 250% or more (250≦) | 260 | 480 | 500 | 180 | 170 | 160 |
| | Heat Deformation (%) Criterion: 50% or less (50≧) | 3.8 | 65.5 | 78.6 | 6.4 | 22.4 | 21.4 |
| | Flame retardant (VFT) Criterion: Fire extinguished within 30 seconds. | X | ◯ | X | ◯ | ◯ | ◯ |

As shown in Table 1, Embodiments 1 to 3 for the flame retardant electric wires and Embodiments 1 to 6 for the flame retardant cables are proved to provide more excellent features in tensile property, extension property, heat deformation property and flame retardant property.

In contrast, Comparison Example 1 in which the amount of EVA is less than the specified value and the amount of PP is more than the specified value has unacceptable flame retardant property, and Comparison Example 2 in which the amount of EVA is more than the specified value and the amount of PP is less than the specified value has less tensile strength property and less heat deformation property than prescribed criteria values.

Comparison Example 3 in which the amount of M-PO and the amount of flame retardant agent are less than the specified values has less tensile strength property and less heat deformation property as well as unsatisfied flame retardant property. Comparison Example 4 in which the amount of M-PO is more than the specified value has less coefficient of extension. Comparison Example 5 which uses polymer denatured with maleic acid not used in the present invention has less extension property. In addition, Comparison Example 6 in which the amount of flame retardant agent is more or less than the specified value ranges does not attain the criteria values for tensile strength property and extension property.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. A non-halogen flame retardant resin composition formed by mixing 100 to 250 parts by weight of silanized magnesium hydroxide together with 100 parts by weight of polymer composed of 50 to 80 parts by weight of ethylene-vinyl acetate copolymer, 10 to 30 parts by weight of polypropylene, and 10 to 20 parts by weight of magnesium hydroxide denatured with maleic acid obtained by denaturing copolymerized polymer with maleic anhydride, the copolymerized polymer being formed by copolymerizing ethylene and the co-monomer of alpha-olefin of carbon numbers 3 to 8.

2. A non-halogen flame-retardant resin composition of claim 1, having a coefficient of extension of 200% or larger when being extended at velocity between 300 mm/min and 500 mm/min in accordance with UIC (The International Union of Railways) Standard.

3. A non-halogen flame retardant electric wire characterized by an insulator layer formed by the resin composition of claim 1 for cladding a conductor.

4. A non-halogen flame retardant cable characterized by a cable sheath formed by the resin composition of claim 1 for cladding an insulated wire.
